(19) United States
(12) Patent Application Publication
(10) Pub. No.: US 2012/0176214 A1
(43) Pub. Date: Jul. 12, 2012

(54) FLATWIRE PLANAR TRANSFORMER

(75) Inventor: Ching Chieh HSIAO, Milpitas, CA (US)

(73) Assignee: WURTH ELECTRONICS MIDCOM INC., Watertown, SD (US)

(21) Appl. No.: 13/342,315

(22) Filed: Jan. 3, 2012

Related U.S. Application Data
(60) Provisional application No. 61/430,725, filed on Jan. 7, 2011.

(51) Int. Cl. H01F 27/28

(52) U.S. Cl. 336/183

(57) ABSTRACT

An interleaved flatwire construction for a flatwire planar transformer is provided. The interleaved flatwire construction includes a first winding wire that includes a first end, a second end and a plurality of first ring portions. The interleaved flatwire construction also includes a second winding wire that includes a first end, a second end and a plurality of second ring portions. A portion of the plurality of first ring portions and a portion of the plurality of second ring portions are interleaved with each other.

This application claims the benefit of priority of U.S. Provisional Application No. 61/430,725, filed on Jan. 7, 2011, and entitled FLATWIRE PLANAR TRANSFORMER, and which is herewith incorporated by reference in its entirety.

### FIELD

This disclosure relates to the field of electrical transformers. More particularly, this description relates to a flatwire planar transformer.

### BACKGROUND

Planar transformers are known. Existing planar transformers use a single multilayer printed circuit board (PCB), or a plurality of PCBs that are stacked on top of each other within the transformer core. However, embedding wire traces into a PCB is expensive. Also, the design and production time for manufacturing the PCB with wire traces that are tailored to a user's desired specifications is time consuming.

Some existing planar transformers are formed by stacking preformed flatwire windings. However, when stacking preformed flatwire windings it becomes difficult to control and regulate the interwinding parasitics (e.g., leakage inductance and capacitance) that are crucial when designing transformers.

### SUMMARY

This application is directed to a flatwire planar transformer with interleaved windings. Particularly, the embodiments herein provide a flatwire planar transformer that is easy to design and manufacture and is less costly than conventional planar transformers that embed wire traces onto a PCB. Also, the embodiments herein provide a flatwire planar transformer that can allow for turn by turn coupling control.

Also, the embodiments herein provide a flatwire planar transformer that can be capable of operating at high frequencies for high power, high current applications in a low profile, highly efficient package. The uniformity of the preformed flatwire windings can allow for highly automated manufacturing processes achieving increased production yields, product quality and reliability.

In particular, the embodiments herein provide a flatwire planar transformer that includes preformed flatwires in an interleaved construction. In some embodiments, the interleaved flatwire planar transformer can use two or more flatwires that are interleaved horizontally. In some embodiments, the interleaved flatwire planar transformer can use two or more flatwires that are interleaved vertically.

Interleaving wires and windings, as defined herein, is directed to portions of two or more winding wires (e.g. a primary winding, a secondary winding, an auxiliary winding, etc.) that are alternately spaced from each other.

In one embodiment, an interleaved flatwire construction for a flatwire planar transformer is provided. The interleaved flatwire construction includes a first winding wire that includes a first end, a second end and a plurality of first ring portions. The interleaved flatwire construction also includes a second winding wire that includes a first end, a second end and a plurality of second ring portions. A portion of the plurality of first ring portions and a portion of the plurality of second ring portions are interleaved with each other.

In another embodiment, a flatwire planar transformer is provided that includes a core and an interleaved flatwire construction housed within the core. The interleaved flatwire construction includes a first winding wire that includes a first end, a second end and a plurality of first ring portions. The interleaved flatwire construction also includes a second winding wire that includes a first end, a second end and a plurality of second ring portions. A portion of the plurality of first ring portions and a portion of the plurality of second ring portions are interleaved with each other.

### DRAWINGS

FIG. 1A provides a top perspective view of an interleaved flatwire planar transformer in which two flatwires are interleaved horizontally, according to one embodiment.

FIG. 1B provides a side perspective view of an interleaved flatwire planar transformer in which two flatwires are interleaved horizontally, according to one embodiment.

FIG. 1C provides a top perspective view of a core housing a horizontal flatwire construction.

FIG. 2A provides a top view of a first winding wire for a horizontal flatwire construction, according to one embodiment.

FIG. 2B provides a side view of a first winding wire for a horizontal flatwire construction, according to one embodiment.

FIG. 2C provides a top view of a second winding wire for a horizontal flatwire construction, according to one embodiment.

FIG. 2D provides a side view of a second winding wire for a horizontal flatwire construction, according to one embodiment.

FIG. 2E provides a top view of a third winding wire for a horizontal flatwire construction, according to one embodiment.

FIG. 2F provides a side view of a third winding wire for a horizontal flatwire construction, according to one embodiment.

FIG. 3A provides a top view of a horizontal flatwire construction using a primary winding, a secondary winding and an auxiliary winding, according to one embodiment.

FIG. 3B provides a side view of a horizontal flatwire construction using a primary winding, a secondary winding and an auxiliary winding, according to one embodiment.

FIG. 4A provides a side view of a first winding wire with a helix portion that includes a plurality of helical rings and a second winding wire with a helix portion that includes a plurality of helical rings, according to one embodiment.

FIG. 4B provides a side view of a horizontal flatwire construction in which a helix portion of a primary winding is 100% interleaved with a helix portion of a secondary winding, according to one embodiment.

FIG. 4C provides a side view of another horizontal flatwire construction in which a helix portion of a primary winding is 60% interleaved with a helix portion of a secondary winding, according to one embodiment.

FIG. 5A provides a top perspective view of an interleaved flatwire planar transformer in which two flatwires are interleaved vertically, according to one embodiment.

FIG. 5B provides a top view of a core housing a vertical flatwire construction, according to one embodiment.

### DETAILED DESCRIPTION

The embodiments provided herein are directed a flatwire planar transformer with interleaved windings. Particularly, the embodiments herein provide a flatwire planar transformer that can be easy to design and manufacture and can be less costly than conventional planar transformers that embed wire traces onto a PCB.

In particular, the embodiments herein provide a flatwire planar transformer that includes preformed flatwires in an interleaved construction. In some embodiments, the interleaved flatwire planar transformer can use two or more flatwires that are interleaved horizontally. In some embodiments, the interleaved flatwire planar transformer can use two or more flatwires that are interleaved vertically.

Interleaving wires and windings, as defined herein, is directed to portions of two or more winding wires (e.g. a primary winding, a secondary winding, an auxiliary winding, etc.) that are alternately spaced from each other.

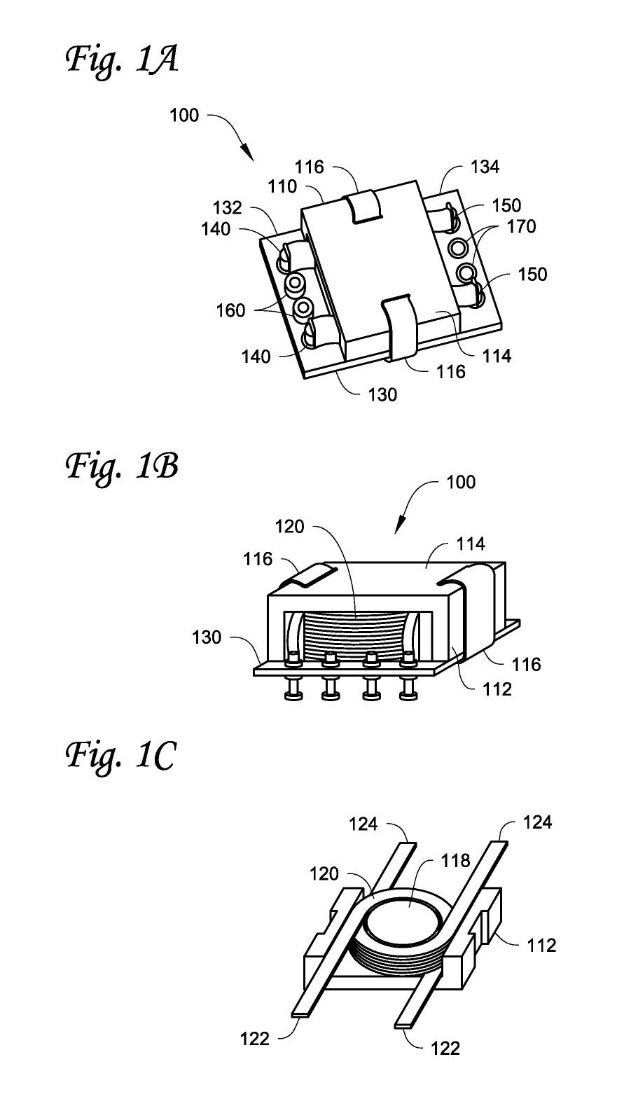

FIGS. 1A and 1B provide a top perspective view and a side perspective view of an interleaved flatwire planar transformer 100 in which two flatwires are interleaved horizontally, according to one embodiment. The transformer 100 includes a core 110, a horizontal flatwire construction 120, a PCB 130, primary winding connectors 140, secondary winding connectors 150, primary external connectors 160 and secondary external connectors 170.

The core 110 in FIGS. 1A and 1B is an ER or ERI core. In some embodiments, the core 110 can also be shaped as an EI or RM core. The core 110 can be a ferrite core composed with magnesium-zinc (MgZn) raw materials. In other embodiments, the ferrite core can be composed with other materials such as iron powder (Fe), nickel-zinc (NiZn), etc.

The horizontal flatwire construction 120 is housed within the core 110 on top of the PCB 130. The core 110 includes a housing 112 and a cover 114 that are attached by clips 116. In one embodiment, the clips 116 can be made of steel. In other embodiments, the clips 116 may not be used and the housing 112 and the cover 114 can be attached using an epoxy.

The PCB 130 is housed within the core 110. The PCB 130 includes a first portion 132 and a second portion 134 that each extend out of the core 110 through an opening on opposite ends of the core 110. The primary winding connectors 140 are attached to the first portion 132 of the PCB 130 and the secondary winding connectors 150 are attached to the second portion 134 of the PCB 130. In some embodiments, the PCB 130 can include one or more transceiver circuits (not shown). In this embodiment, the PCB 130 includes a single winding turn on the top side of the PCB 130 and a single winding turn on the bottom side of the PCB 130. The two winding turns of the PCB 130 are used as auxiliary windings. Also, the PCB 130 is used as a platform base for attaching and positioning terminal solder pins. In some embodiments, the PCB 130 may not be used and can be replaced with a plastic platform base. The plastic platform base can be provided for stability to the transformer 100 and for manufacturing purposes.

FIG. 1C provides a top perspective view of the housing 112 of the core 110 housing the horizontal flatwire construction 120. The flatwire construction 120 fits around a projection 118 of the housing 112. The flatwire construction 120 includes a primary winding wire 122 interleaved with a secondary winding wire 124. The flat portions of the primary winding 122 and the secondary winding 124 (e.g. the wide surfaces of the primary and secondary windings 122, 124) of the horizontal flatwire construction 120 are arranged so as to rest horizontally onto the housing 112. Both the primary winding wire 122 and the secondary winding wire 124 are made of copper. In some embodiments, the primary winding wire 122 and/or the secondary winding wire 124 can be made of, for example, aluminum, brass, phosphor bronze, nickel, silver, or a combination of copper with other metals, etc.

As shown in FIG. 1A, a top portion and a bottom portion of the primary winding wire 122 are electrically connected to the PCB 130 via the primary winding connectors 140. Similarly, a top portion and a bottom portion of the secondary winding wire 124 are electrically connected to the PCB 130 via the secondary winding connectors 140. The primary external connectors 160 and the secondary external connectors 170 are provided for allowing external electrical components to connect to the flatwire planar transformer 100. In this embodiment, the top and bottom portions of the primary and secondary winding wires 122, 124 can be welded to the PCB 130 and the primary and secondary winding connectors 140, 150, respectively. In other embodiments, the primary and secondary winding wires 122, 124 can be soldered to the PCB 130. In yet some other embodiments, the primary and secondary winding wire connectors 140, 150 may not be used and the primary and secondary winding wires 122, 124 can be formed as terminal pins and attached to the PCB 130.

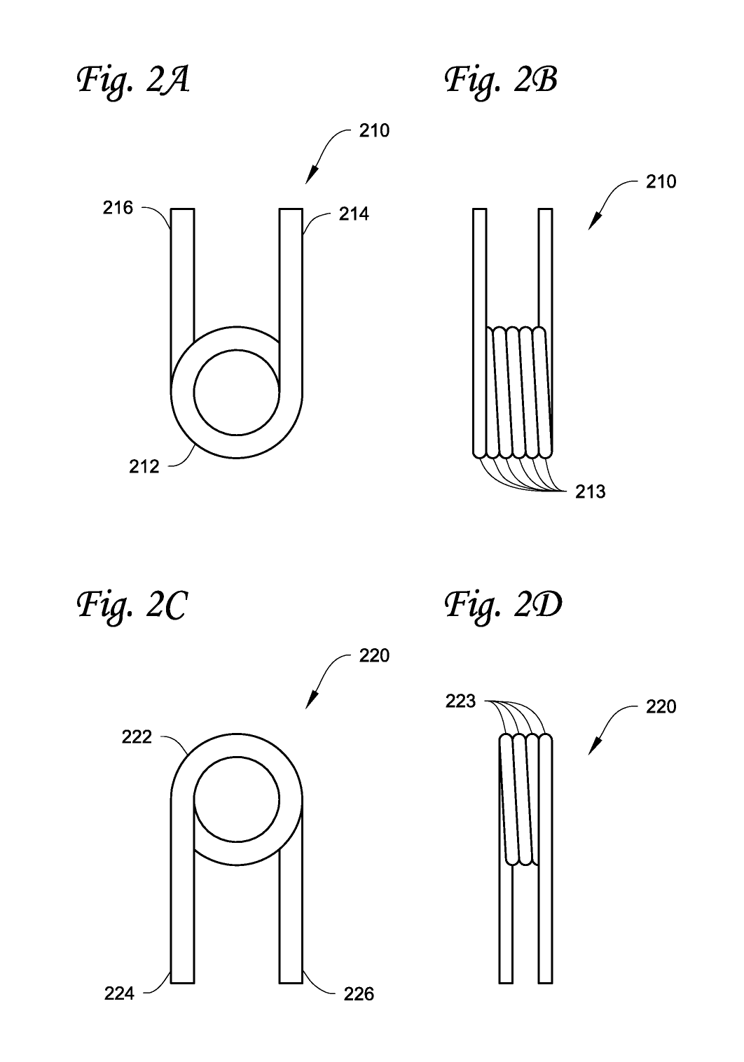

FIGS. 2A-F provide top and side views, respectively, of a first winding wire 210, a second winding wire 220, and a third winding wire 230. As shown in FIGS. 2A-F, the first winding wire 210, the second winding wire 220, and the third winding wire 230 each include a helix portion 212, 222, 232, a top end portion 214, 224, 234, and a bottom end portion 216, 226, 236, respectively.

The helix portions 212, 222, 232 are made up of a plurality of helical rings 213, 223, 233 that indicate the number of turns for each of the winding wires 210, 220, 230. For example, the helical rings 213 of the first winding wire 210 form 5.75 turns, the helical rings 223 of the second winding wire 220 form 3.75 turns, and the helical rings 233 of the third winding wire 230 includes 1.75 turns.

In the embodiments shown in FIGS. 2A-F, the length of each of the top end portions 214, 224, 234 and each of the bottom end portions 216, 226, 236 can be about 10 mm in length. Also, the diameter of each of the helical rings 213, 223, 233 can be about 10 mm in length and a distance between each of the helical rings 213, 223, 233 is between about 3.6 mm and about 20 mm. In other embodiments, the diameter of the helical rings 213, 223, 233 and the maximum distance between each of the helical rings 213, 223, 233 can vary, based on user requirements.

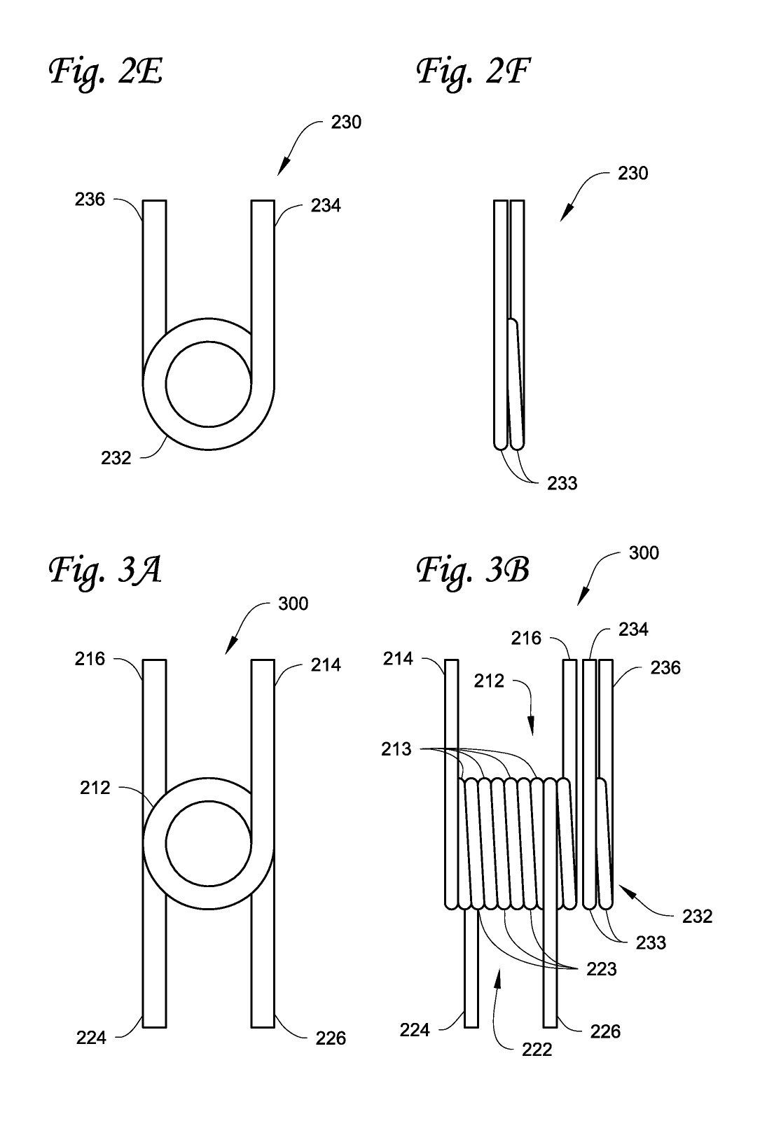

FIGS. 3A-B provide a top and side view, respectively, of a horizontal flatwire construction 300 using the first winding wire 210 as the primary winding, the second winding wire 220 as the secondary winding and the third winding wire 230 as the auxiliary winding. The auxiliary winding can be provided as an additional outlet from which power can be drawn from. In some embodiments, the auxiliary winding can be connected to auxiliary connectors which can be located on either primary side or secondary side connectors. As shown in FIG. 3B, the third winding wire 230 would be connected to auxiliary connectors located at the same location as the connectors for the first winding wire 210. The helix portion 212 and 222 are interleaved horizontally such that each of the helical rings 213 and 223 can be alternately spaced from each other and form a stacked configuration. By interleaving the helix portion 212 and the helix portion 222, the horizontal flatwire construction 300 can achieve improved control of winding parasitics, particularly improved leakage inductance. The interleaved helix portions 212 and 222 are then stacked on top of the helix portion 232.

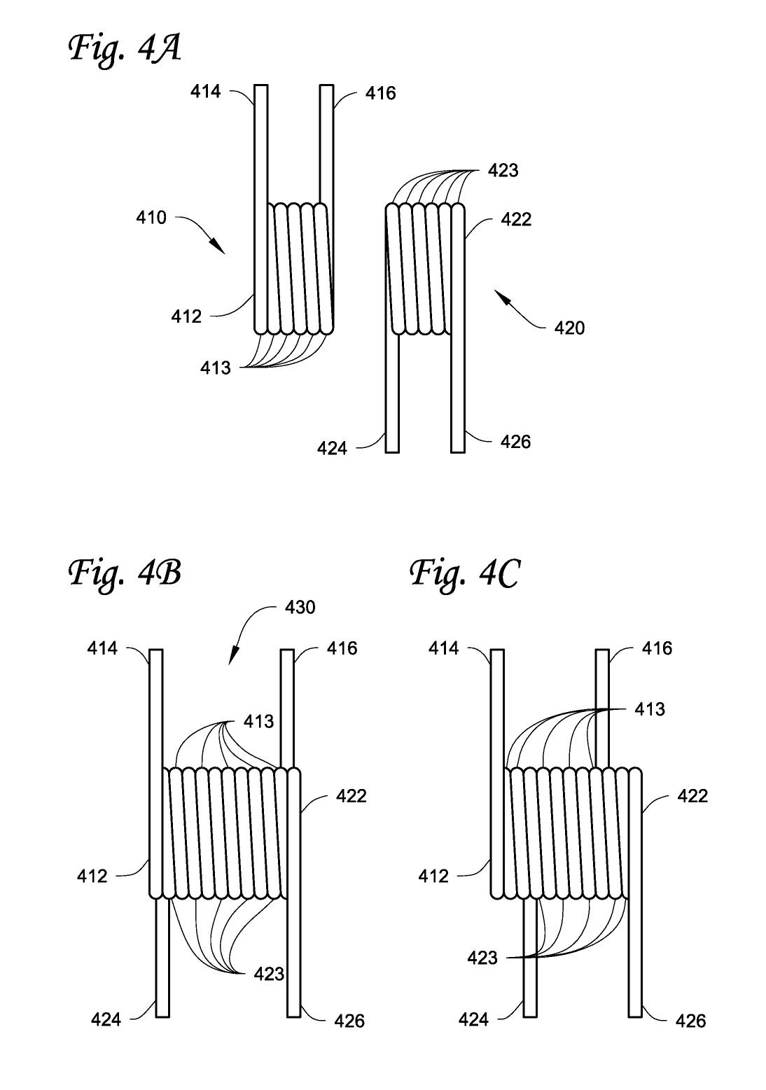

FIG. 4A provides a side view of a first winding wire 410 with a helix portion 412 that includes a plurality of helical rings 413 and a second winding wire 420 with a helix portion 422 that includes a plurality of helical rings 423. The first winding wire 410 also includes a top portion 414 and a bottom portion 416. Similarly, the second winding wire 420 includes a top portion 424 and a bottom portion 426. FIG. 4B provides a side view of a horizontal flatwire construction 430 in which the helix portion 412 of the first winding wire 410 is 100% interleaved with the helix portion 422 of the second winding wire 420 so that each of the helical rings 413 can be interleaved with each of the helical rings 423. FIG. 4C provides a side view of a second horizontal flatwire construction 440 in which the helix portion 412 of the first winding wire 410 is 60% interleaved with the helix portion 422 of the second winding wire 420 so that 60% of the helical rings 413 and the helical rings 423 can be interleaved with each other. By varying the percentage of interleaving between the helical rings 413 and the helical rings 423, the winding parasitics (including, for example, leakage inductance and interwinding capacitance) of a flatwire planar transformer can be modified and controlled.

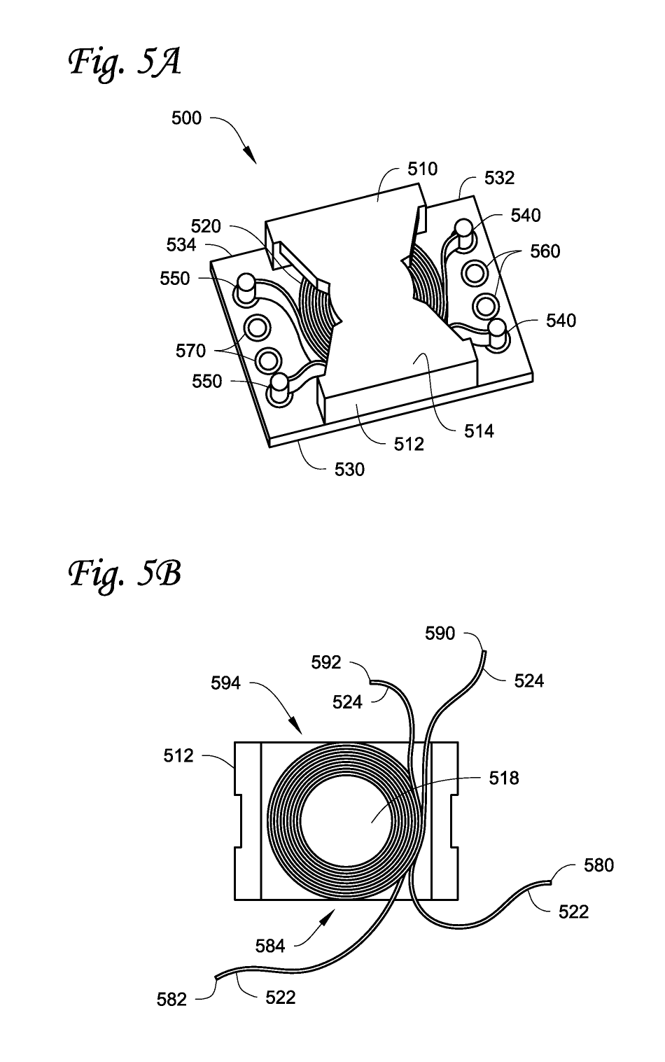

FIG. 5A provides a top perspective view of an interleaved flatwire planar transformer 500 in which two flatwires are interleaved vertically, according to another embodiment. The transformer 500 includes a core 510, a vertical flatwire construction 520, a PCB 530, primary winding connectors 540, secondary winding connectors 550, primary external connectors 560 and secondary external connectors 570. In this embodiment, the vertical flatwire planar transformer 500 is configured to act as a common-mode choke (CMC). In other embodiments, the vertical flatwire planar transformer 500 can be configured as a power transformer, a coupled inductor, etc.

The core 510 is a RM shaped core. In some embodiments, the core 510 can also be shaped as an EI or ER core. The core 510 can be a ferrite core composed with magnesium-zinc (MgZn) raw materials. In other embodiments, the ferrite core can be composed with other ferrite materials such as iron powder (Fe), nickel-zinc (NiZn), etc.

The vertical flatwire construction 520 is housed within the core 510 on top of the PCB 530. The core 510 includes a housing 512 (shown in FIG. 5B) and a cover 514 that are attached by clips (not shown).

The PCB 530 is housed within the core 510. The PCB 530 includes a first portion 532 and a second portion 534 that each extend out of the core 510 through an opening on opposite ends of the core 510. The primary winding connectors 540 are attached to the first portion 532 of the PCB 530 and the secondary winding connectors 550 are attached to the second portion 534 of the PCB 530. In some embodiments, the PCB 530 can include one or more transceiver circuits (not shown).

FIG. 5B provides a top perspective view of the housing 512 of the core 510 housing the vertical flatwire construction 520. The flatwire construction 520 fits around a projection 518 of the housing 512. The flatwire construction 520 includes a primary winding wire 522 interleaved with a secondary winding wire 524.

In particular, the primary winding wire 522 includes a first end 580, a second end 582 and a plurality of primary ring portions 584. Similarly, the secondary winding wire 524 includes a first end 590, a second end 592 and a plurality of secondary ring portions 594. The plurality of primary ring portions 584 and the plurality of secondary ring portions 594 are vertically interleaved with each other such that the primary ring portions 584 and the secondary ring portions 594 are alternately arranged in a concentric configuration. In other embodiments, a portion of the plurality of primary ring portions 584 and a portion of the secondary ring portions 594 can be vertically interleaved with each other (not shown). As opposed to a horizontal flatwire construction, the flat portions of the primary winding 522 and the secondary winding 524 (e.g. the wide surfaces of the primary and secondary windings 522, 524) of the vertical flatwire construction 520 are arranged so as to rest vertically onto the housing 512. Both the primary winding wire 522 and the secondary winding wire 524 can be made of copper. In some embodiments, the primary winding wire 522 and/or the secondary winding wire 524 can be made of, for example, aluminum, brass, phosphor bronze, nickel, silver, or a combination of copper with other metals, etc.

As shown in FIG. 5A, a first portion and a second portion of the primary winding wire 522 are electrically connected to the PCB 530 via the primary winding connectors 540. Similarly, a first portion and a second portion of the secondary winding wire 524 are electrically connected to the PCB 530 via the secondary winding connectors 540. In this embodiment, the first and second portions of the primary and secondary winding wires 522, 524 are welded or soldered to the PCB 530 and the primary and secondary winding connectors 540, 550, respectively. The primary external connectors 560 and the secondary external connectors 570 can allow external electrical components to connect to the interleaved flatwire planar transformer 500.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An interleaved flatwire construction for a flatwire planar transformer, comprising:
a first winding wire that includes a first end, a second end and a plurality of first ring portions; and
a second winding wire that includes a first end, a second end and a plurality of second ring portions;
wherein a portion of the first ring portions of the first winding wire and a portion of the second ring portions of the second winding wire are interleaved with each other.

2. The interleaved flatwire construction of claim 1, further comprising a third winding wire that includes a first end, a second end and a plurality of third ring portions, and
wherein a portion of the third ring portions are interleaved with a portion of the first ring portions or the second ring portions.

3. The interleaved flatwire construction of claim 1, wherein the plurality of first ring portions are first helical rings, the plurality of second ring portions are second helical rings, and a portion of the first helical rings are interleaved with the second helical rings.

4. The interleaved flatwire construction of claim 3, wherein both the first and second winding wires include a wide surface, and the portion of the first helical rings and the portion of the second helical rings are horizontally interleaved with each other such that the wide surface of the portion of the first helical rings and the wide surface of the portion of the second helical rings are alternately arranged in a stack configuration.

5. The interleaved flatwire construction of claim 1, wherein both the first and second winding wires include a wide surface, and the portion of the first ring portions and the portion of the second ring portions are vertically interleaved with each other such that the wide surface of the portion of the first ring portions and the wide surface of the portion of the second ring portions are alternately arranged in a concentric configuration.

6. The interleaved flatwire construction of claim 1, wherein the first and second winding wires are composed of one of copper, aluminum, brass, phosphor bronze, nickel, or silver.

7. A flatwire planar transformer, comprising:
a core; and
an interleaved flatwire construction housed within the core, the interleaved flatwire construction including a first winding wire that includes a first end, a second end and a plurality of ring portions, and a second winding wire that includes a first end, a second end and a plurality of second ring portions, wherein a portion of the plurality of first ring portions and a portion of the plurality of second ring portions are interleaved with each other.

8. The flatwire planar transformer of claim 7, wherein the interleaved flatwire construction further includes a third winding wire that includes a first end, a second end and a plurality of third ring portions, and
wherein a portion of the third ring portions are interleaved with a portion of the first ring portions or the second ring portions.

9. The flatwire planar transformer of claim 7, wherein the plurality of first ring portions are first helical rings, the plurality of second ring portions are second helical rings, and a portion of the first helical rings are interleaved with the second helical rings.

10. The flatwire planar transformer of claim 9, wherein both the first and second winding wires include a wide surface, and the portion of the first helical rings and the portion of the second helical rings are horizontally interleaved with each other such that the wide surface of the portion of the first helical rings and the wide surface of the portion of the second helical rings are alternately arranged in a stack configuration.

11. The flatwire planar transformer of claim 7, wherein both the first and second winding wires include a wide surface, and the portion of the first ring portions and the portion of the second ring portions are vertically interleaved with each other such that the wide surface of the portion of the first ring portions and the wide surface of the portion of the second ring portions are alternately arranged in a concentric configuration.

12. The flatwire planar transformer of claim 7, wherein the first and second winding wires are composed of one of copper, aluminum, brass, phosphor bronze, nickel, or silver.

13. The flatwire planar transformer of claim 7, wherein the core includes a housing for the interleaved flatwire construction, a cover, and one or more clips attaching the cover to the housing.

14. The flatwire planar transformer of claim 7, further comprising a printed circuit board housed within the core, the printed circuit including a first portion and a second portion,
wherein the core includes an opening at opposite ends of the core such that first and second portions of the printed circuit board extend out of the core.

15. The flatwire planar transformer of claim 7, wherein the core is a ferrite core
